(19) United States
(12) Patent Application Publication
(10) Pub. No.: US 2005/0064208 A1
(43) Pub. Date: Mar. 24, 2005

(54) Light-transmitting substrate provided with a light-absorbing coating

(76) Inventors: Marcel Rene Boehmer, Singapore (SG); Melanie Maria Hubertina Wagemans, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/502,158

(22) PCT Filed: Jan. 15, 2003
(86) PCT No.: PCT/IB03/00084

(30) Foreign Application Priority Data
Jan. 24, 2002 (EP) 02075301.8

(51) Int. Cl. B05D 3/02; B32B 9/04

(52) U.S. Cl. 428/447; 427/372.2

(57) ABSTRACT

Disclosed is a light-transmitting substrate which is at least partly provided with a light-absorbing coating. Said coating comprises light-absorbing particles that are incorporated in a sol-gel matrix. The light-absorbing particles comprise silver or gold or a mixture thereof, and the coating further comprises a dimethyl-aminosilane. Furthermore, an electric lamp is disclosed comprising a light-transmitting lamp vessel that accommodates a light source. Said lamp vessel comprises the above light-transmitting substrate. A method of preparing a light-absorbing coating to be applied to a light-transmitting substrate, and a method of applying a light-absorbing coating to a light-transmitting substrate are also disclosed.

The present invention relates to a light-transmitting substrate that is at least partly provided with a light-absorbing coating, said coating comprising light-absorbing particles that are incorporated in a sol-gel matrix. The invention further relates to an electric lamp comprising a light-transmitting lamp vessel that accommodates a light source, wherein said lamp vessel comprises the above light-transmitting substrate. Furthermore, the present invention relates to a method of preparing a light-absorbing coating to be applied to a light-transmitting substrate, as well as a method of applying a light-absorbing coating to a light-transmitting substrate.

Light-transmitting substrates provided with a light absorbing coating can be used as color layers on or in front of (incandescent) lamps for general lighting purposes. The substrate may comprise, for example, a colored filter made of a piece of glass, which may or may not be flat and which is designated to be placed in a trajectory of light, said light being generated by a lamp. Such an application is often used in outdoor lighting. Another example of a light-transmitting substrate is a lamp vessel that is placed over a light source of an electric lamp. Such electric lamps are predominantly used as indicator lamps in vehicles, for example as an amber-colored light source in indicators or as a red-colored light source in brake lights of automobiles. Alternative embodiments of such lamps, wherein the color temperature is increased by means of a light-absorbing coating, may also be used as headlamps of a vehicle. Said electric lamps may also be used in traffic lights.

An electric lamp having a lamp vessel that comprises the light-transmitting substrate according to the preamble is known from WO 01/20641 as filed by the present applicant.

The light-transmitting substrate according to WO 01/20641 is provided with an optically transparent, non-scattering, light-absorbing coating in which pigments are incorporated in a sol-gel matrix and which can resist temperatures of up to 400° C.

To manufacture light-absorbing coatings having the desired optical properties as well as having the desired thermal stability during the service life of the electric lamp, use is preferably made of inorganic pigments. In particular, the pigment is selected from the group formed by iron oxide, iron oxide doped with phosphor, zinc-iron oxide, cobalt aluminate, neodymium oxide, bismuth vanadate, zirconium-praseodymium silicate, or mixtures thereof. Iron oxide (Fe₂O₃) is an orange pigment and P-doped Fe₂O₃ is an orange-red pigment. Zinc-iron oxide, for example ZnFe₂O₄ or ZnO.ZnFe₂O₄ are yellow pigments. Mixing (P-doped) Fe₂O₃ with ZnFe₂O₄ yields a pigment of a deep orange color. Cobalt aluminate (CoAl₂O₄) and neodymium oxide (Nd₂O₅) are blue pigments. Bismuth vanadate BiVO₄), also referred to as pucherite, is a yellow-green pigment. Zirconium-praseodymium silicate is a yellow pigment.

Although the above inorganic pigments do not show discoloration at high temperatures, they often incline towards having a thermochromic effect leading to a decrease in the lumen output if operated at high temperatures.

It is an object of the present invention to overcome the above drawback. Moreover, it is an object of the present invention to make transparent red, yellow, and blue coatings that are stable at high temperatures and that do not show a thermochromic effect.

To this end the present invention provides for a light-transmitting substrate according to the preamble that is characterized in that the light-absorbing particles of the light-absorbing coating comprise silver or gold or a mixture thereof, and in that the coating further comprises a dimethyl-aminosilane.

By using silver or gold in a sol-gel matrix in the presence of a dimethyl-aminosilane, transparent high temperature stable coatings can be obtained that show no thermochromic effect. The dimethyl-aminosilane acts as a stabilizer and helps controlling the particle size.

The position of the absorption maximum of the coating can be tuned by the refractive index of the matrix. In MTMS/TEOS with a refractive index of about 1.46, yellow silver-containing coatings can be made. Silver in TiO2 or a TiO2/MTMS mixture can be used to make amber and, in case of an increase of the refractive index of the TiO2 matrix, also red. Gold-containing coatings in MTMS/TEOS are red. In a TiO₂ matrix the gold containing coatings are blue.

The advantage of dimethyl-aminosilane is that dimethyl-aminosilane does not promote the sol-gel condensation reactions very strongly, whereas other aminosilanes promote the sol-gel condensation reactions too strongly. Coating liquids with an acceptable pot life can be made with the use of dimethyl-aminosilane.

Moreover, the use of dimethyl-aminosilane in the light-absorbing coating makes it possible to cure said coating at a temperature of about 350° C., which is a considerably lower temperature than the curing temperature of comparable coatings that do not contain dimethyl-aminosilane. An advantage of such a lower curing temperature is that the substrate characteristics are not limited to a large extent. For example, the application of the coating is not restricted only to quartz glass, but ordinary soda-lime glass and simple lamp glass types can also be used as a substrate.

An additional benefit of the low curing temperature according to the present invention, if silver is used, is that the absorption peak for silver is very sharp. This results in a bright color of the coating layer.

By way of comparison, reference is made to U.S. Pat. No. 5,731,091 in which a coating is disclosed that comprises silver or gold in a sol-gel matrix in the presence of an aminosilane. The specific aminosilanes that are used according to said patent are 3-aminopropyl-triethoxysilane and 3-3-(aminoethylamino)-propyl-triethoxysilane. The coatings according to U.S. Pat. No. 5,731,091 are cured at a temperature of 500° C. Obviously, this high curing temperature does not lead to the above-mentioned advantages of the present invention. Moreover, U.S. Pat. No. 5,731,091 discloses a yellowish-brown coating that is obtained when silver is used. Such a non-bright color is due to a less sharp absorption peak.

The dimethyl-aminosilane used advantageously comprises a dimethyl-aminopropyl-trialkoxysilane such as (N,N-dimethyl-aminopropyl)trimethoxysilane or (N,N-dimethyl-aminopropyl)triethoxysilane.

Depending on the specific application, the substrate may comprise a specific composition. In a preferred embodiment, the substrate comprises a glass substrate.

The present invention also relates to an electric lamp comprising a light-transmitting lamp vessel which accommodates a light source, said lamp vessel comprising a light-transmitting substrate according to the above.

As will be clear from the above, said lamp is suitable for use as an indicator lamp in vehicles.

Furthermore, the present invention provides for a method of preparing a light-absorbing coating to be applied to a light-transmitting substrate according to the above, said method at least comprising the steps of:

preparing a hydrolysis mixture comprising a silane compound or a titanium compound that is subjected to a sol-gel process;

dissolving a silver salt or a gold salt in an alcohol-comprising liquid and adding an dimethyl-aminosilane; and

mixing the hydrolysis mixture and the silver or gold salt solution.

A matrix of both SiO₂ and TiO₂ may be used to incorporate the silver or gold particles.

Finally, the present invention relates to a method of applying a light-absorbing coating to a light-transmitting substrate according to the above, said method comprising the steps of:

applying a light-absorbing coating obtained by the above method according to the invention to a light-transmitting substrate; and

curing the light-absorbing coating at a temperature in a range of 300° C. to 395° C.

The light-absorbing coating according to the present invention distinguishes itself from the prior art in that the temperature at which it can be cured can be as low as about 350° C. When the coating according to the present invention is applied to a substrate and cured in the above temperature range, a stable transparent coating is obtained which shows no thermochromic effect. Due to the fact that dimethyl-aminosilane is present, a curing temperature as low as about 350° C. is sufficient.

This is also contrary to the teaching of WO 98/18736, in which curing temperatures as high as 600-900° C. are mentioned. WO 98/18736 differs from the present invention in that the matrix in which the light-absorbing particles are incorporated does not comprise a sol-gel matrix. The combination of silver or gold in a sol-gel matrix in the presence of a dimethyl-aminosilane is not disclosed.

If the coating according to the present invention comprises silver, the curing is performed in a reducing atmosphere.

The present invention will be elucidated by means of the following manufacturing examples of preparing a coating and applying said coating to a substrate.

### EXAMPLE 1

Gold in MTMS/TEOS

A sol-gel hydrolysis mixture is made by mixing 0.56 g ethanol, 1.63 g methyltrimethoxy silane (MTMS), 2.31 g tetraethoxy silane (TEOS), and 1.3 g 0.1 M HCl, and subjecting said mixture to hydrolysis during 4 hours. After said period 1.2 g methoxypropanol and 1.7 g water are added.

Separately, 0.3 g KAuCl₄ is dissolved in 2.2 g ethanol. After dissolution thereof, aminosilane is added in such an amount that a molar ratio gold:aminosilane of 1:2 is obtained.

A coating liquid is prepared by mixing the gold solution and the sol-gel hydrolysis mixture. The coating liquid is subsequently spin-coated onto the outer surface of a glass substrate. The coating is cured for 30 minutes at a temperature of 350° C., resulting in a red coating with an absorption maximum at 520 nm. The layer thickness is 1.1 μm.

### EXAMPLE 2

Silver in MTMS/TEOS

For silver in MTMS/TEOS the method according to example 1 is followed, except that the gold salt is replaced by AgNO₃.

AgNO₃ is dissolved in methanol in such amount that the aminosilane:Ag molar ratio is 1:1.

The coating liquid is prepared by mixing the silver solution and the sol-gel hydrolysis mixture. The coating liquid is subsequently spin-coated onto a glass substrate. After curing for 30 minutes at a temperature of 350° C. in air not all silver had been converted. Continuation of the curing in H₂ at 350° C. led to an intensively colored yellow coating with an absorption maximum at 394 nm. The layer thickness is 1.1 μm.

It will be clear that the present invention is not limited to the above examples. Although MTMS/TEOS is specifically mentioned as a matrix precursor for a SiO₂ matrix, it is pointed out that a TiO2 matrix may alternativeley be applied according to the present invention.

1. A light-transmitting substrate which is at least partly provided with a light-absorbing coating, said coating comprising light-absorbing particles that are incorporated in a sol-gel matrix, characterized in that the light-absorbing particles comprise silver or gold or a mixture thereof, and in that the coating further comprises a dimethyl-aminosilane.

2. A light-transmitting substrate as claimed in claim 1, characterized in that the dimethyl-aminosilane comprises a dimethyl-aminopropyl-trialkoxysilane.

3. A light-transmitting substrate as claimed in claim 1, characterized in that the dimethyl-aminosilane comprises (N,N-dimethyl-aminopropyl)trimethoxysilane or (N,N-dimethyl-aminopropyl)triethoxysilane.

4. A light-transmitting substrate as claimed in claim 1, characterized in that the substrate comprises a glass substrate.

5. An electric lamp comprising a light-transmitting lamp vessel which accommodates a light source, said lamp vessel comprising a light-transmitting substrate as claimed in claim 1.

6. A method of preparing a light-absorbing coating to be applied to a light-transmitting substrate as claimed in claim 1, at least comprising the steps of:
preparing a hydrolysis mixture comprising a silane compound or a titanium compound that is subjected to a sol-gel process;
dissolving a silver salt or a gold salt in an alcohol-comprising liquid and adding an dimethyl-aminosilane; and
mixing the hydrolysis mixture and the silver or gold salt solution.

7. A method of applying a light-absorbing coating to a light-transmitting substrate as claimed in claim 1, said method comprising the steps of:
applying a light-absorbing coating obtained in accordance with to claim 6 to a light-transmitting substrate; and
curing the light-absorbing coating at a temperature in a range of 300° C. to 395° C.

8. A method as claimed in claim 7, characterized in that the curing step is performed at a temperature of 350° C.

9. A method as claimed in claim 7, characterized in that the coating comprises silver, and in that the curing is performed in a reducing atmosphere.
